(19) United States
(12) Patent Application Publication
(10) Pub. No.: US 2014/0019760 A1
(43) Pub. Date: Jan. 16, 2014

(54) METHOD FOR PERSONALIZING A SECURE ELEMENT COMPRISED IN A TERMINAL

(71) Applicants: Fabrice Vergnes, Fuveau (FR); Frédéric Faria, La Ciotat Cedex (FR); Franck Imoucha, Auriol (FR)

(72) Inventors: Fabrice Vergnes, Fuveau (FR); Frédéric Faria, La Ciotat Cedex (FR); Franck Imoucha, Auriol (FR)

(73) Assignee: GEMALTO SA, Meudon (FR)

(21) Appl. No.: 13/992,065

(22) PCT Filed: Dec. 2, 2011
(86) PCT No.: PCT/EP2011/071664

§ 371 Date: Aug. 29, 2013

Related U.S. Application Data
(63) Continuation of application No. 13/312,309, filed on Dec. 6, 2011.

(30) Foreign Application Priority Data
Dec. 6, 2010 (EP) 10306359.0

(51) Int. Cl. H04L 29/06

(52) U.S. Cl. CPC H04L 63/0823
USPC 713/175

(57) ABSTRACT

The invention proposes a method for personalizing a first secure element comprised in a first terminal, said method consisting in:
Providing the user of the first terminal with a second secure element;
Linking the first and second secure elements in or through the first terminal;
Personalizing securely the first secure element with data comprised in the second secure element, security being based on certificate verification and asymmetric encryption between the secure elements.

This disclosure is a national phase of PCT/EP2011/071664, filed Dec. 2, 2011, a continuation of U.S. application Ser. No. 13/312,309, filed Dec. 6, 2011, and claims priority to European Application No. 10306359.0, filed Dec. 6, 2010, the disclosures of which are hereby incorporated by reference.

The present invention concerns a method for personalizing a secure element comprised in a terminal.

Typically, in the telecommunication domain, a secure element is constituted by an element like a UICC (Universal Integrated Circuit Card) embedding Sim applications, this secure element being installed, fixedly or not, in a terminal, like for example a mobile phones. In some cases, the terminal is constituted by a machine that communicates with other machines for M2M (Machine to Machine) applications.

A UICC can be in the format of a smart card, or may be in any other format such as for example but not limited to a packaged chip as described in PCT/SE2008/050380, or any other format. It can be used in mobile terminals in GSM and UMTS networks for instance. The UICC ensures network authentication, integrity and security of all kinds of personal data.

In a GSM network, the UICC contains mainly a SIM application and in a UMTS network it is the USIM application. A UICC may contain several other applications, making it possible for the same smart card to give access to both GSM and UMTS networks, and also provide storage of a phone book and other applications. It is also possible to access a GSM network using an USIM application and it is possible to access UMTS networks using a SIM application with mobile terminals prepared for this. With the UMTS release 5 and later stage network like LTE, a new application, the IP multimedia Services Identity Module (ISIM) is required for services in the IMS (IP Multimedia Subsystem). The telephone book is a separate application and not part of either subscription information module.

In a CDMA network, the UICC contains a CSIM application, in addition to 3GPP USIM and SIM applications. A card with all three features is called a removable user identity card, or R-UIM. Thus, the R-UIM card can be inserted into CDMA, GSM, or UMTS handsets, and will work in all three cases.

In 2G networks, the SIM card and SIM application were bound together, so that “SIM card” could mean the physical card, or any physical card with the SIM application.

The UICC smart card consists of a CPU, ROM, RAM, EEPROM and I/O circuits. Early versions consisted of the whole full-size (85×54 mm, ISO/IEC 7810 ID-1) smart card.

Since the card slot is standardized, a subscriber can easily move their wireless account and phone number from one handset to another. This will also transfer their phone book and text messages. Similarly, usually a subscriber can change carriers by inserting a new carrier's UICC card into their existing handset. However, it is not always possible because some carriers (e.g. in U.S.) SIM-LOCK the phones that they sell, thus preventing competitor carriers' cards being used.

The integration of the ETSI framework and the Application management framework of Global Platform is standardized in the UICC configuration.

UICCs are standardized by 3GPP and ETSI.

A UICC can normally be removed from a mobile terminal, for example when the user wants to change his mobile terminal. After having inserted his UICC in his new terminal, the user will still have access to his applications, contacts and credentials (network operator).

It is also known to solder or weld the UICC in a terminal, in order to get it dependent of this terminal. This is done in M2M (Machine to Machine) applications. The same objective is reached when a chip (a secure element) containing the SIM or USIM applications and files is contained in the terminal. The chip is for example soldered to the mother-board of the terminal or machine and constitutes an e-UICC.

A parallel can be done for UICCs that are not totally linked to devices but that are removable with difficulty because they are not intended to be removed, located in terminals that are distant or deeply integrated in machines. A special form factor of the UICC (very small for example and therefore not easy to handle) can also be a reason to consider it as in fact integrated in a terminal. The same applies when a UICC is integrated in a machine that is not intended to be opened.

In the next description, welded UICCs or chips containing or designed to contain the same applications than UICCs will generally be called embedded UICCs or embedded secure elements (in contrast to removable UICCs or removable secure elements). This will also apply to UICCs or secure elements that are removable with difficulty.

The present invention concerns the personalization of a secure element by using another secure element in post-issuance.

Secure personalization of secure elements is a heavy step in industrialization and distribution of services on secure elements.

This invention proposes to not performing this step in factories but to let the user do it according to its needs.

Credentials' porting from one secure element to the other one has not been possible so far. Until now, it meant replacement of an old secure element by a new secure element already personalized with partial porting of the credentials.

This invention proposes a method to port credentials from one secure element to another.

The invention also aims to allow to an end-user to personalize an embedded secure element (embedded UICC) by transferring data to this embedded UICC, after post-issuance. This can for example consist in transferring to the embedded UICC a new application, like a banking application for example.

In case of personalization of an embedded UICC, the invention proposes a method for personalizing a first secure element comprised in a first terminal, said method consisting in:
Providing the user of the first terminal with a second removable secure element;
Linking the first and second secure elements in or through the first terminal;
Personalizing securely the first secure element with data comprised in the second removable secure element, security being based on certificate verification and asymmetric encryption between the secure elements.

The first and second secure elements can be removable or not (embedded UICC). When the second secure element is removable, its form factor can be a Sim card or a dongle for example. It can also be comprised in a so called “smart badge” having a wireless link with the first secure element. It can also be comprised in a mobile terminal, under a non-removable form (embedded UICC or e-UICC).

The personalization can be done in a public area without any network access, by anyone, e.g. the end user, anywhere, e.g. at end user home, and without any connectivity constraint.

This personalization can for example consist in a transfer of credentials (Imsi, Ki) of a banking application from a mobile terminal, for example a mobile phone, to another one.

In a given example, the process for personalization is for example the following:
A user who wishes to personalize his first secure element, for example included in a mobile phone, goes to his bank or to a shop of his mobile network operator and receives a second secure element in the form of a dongle. The dongle contains an application or credentials that have to be transferred to the first secure element. The dongle can also be sent to him per post;
Once at home, the user inserts his dongle in his computer and connects his mobile phone to the computer. The link between the computer and the mobile phone can be wireless (Wifi or Wifi Direct, Bluetooth, NFC, . . . ) or wired.
Thanks to an application comprised in the computer or in the dongle, the application or the credentials that have to be written in the first secure element are transferred to the latter.
Once transferred, the application or the credentials can be used in the first secure element, for example for e-banking.

The invention also applies to the personalization of a secure element embedded in a terminal, for example in a PC. The second secure element is simply plugged in the PC and the personalization occurs.

For securing the point-to-point personalization, certificate verification and asymmetric encryption are used. The security relies on the second secure element (in any form factor) and the use of a PKI scheme allowing an authentication between the two secure elements.

The personalization happens after the issuance of the secure element to be personalized. This is in particular useful when an end user already owns a secure element, e.g. a smart card in its mobile phone, a banking card, a secure element in a PC, or any other device. When the user needs/wants to transfer its credentials to a brand new secure element, the existing secure element can transfer the credentials contained therein (subscription to a MNO, entire Sim application with IMSI and KI, content of an e-purse, . . . ) to the new secure element. This may happen securely in the field, the user only needs to hold physically both secure elements.

This is also applicable when the end user wants to add a new service provided by any Service Provider on an existing secure element. He can be provided with a secure element able to personalize its first secure element without being required to connect to Internet nor to go in a shop.

The invention allows also updating the personalization of a secure element post issuance. This is also true for an update of the secure element personalization.

The invention permits to reduce personalization cost in factories and allows secure post-issuance personalization. The end user does not need to go to the service provider shop, nor to connect to Internet to personalize/update its secure element. Moreover, security is granted by point-to-point personalization relying on two secure elements. This is also simplified by the non connected process (no virus threat).

1. Method for personalizing a first secure element comprised in a first terminal, said method comprising:
Providing the user of said first terminal with a second removable secure element;
Linking said first and second secure elements in or through said first terminal;
Personalizing securely said first secure element with data comprised in said second removable secure element, security being based on certificate verification and asymmetric encryption between said secure elements.

2. (canceled)

3. Method according to claim 1, wherein said first secure element is an e-UICC.

4. Method according to claim 1, wherein said second removable secure element is a Sim card.

5. Method according to claim 1, wherein said second removable secure element is a dongle.

6. Method according to claim 5, wherein said dongle contains an application or credentials to be transferred to said first secure element.

7. Method according to claim 5, wherein said linking of said first and second secure elements is realized through a computer in which said dongle is inserted.

8. Method according to claim 1, wherein said second removable secure element is a banking card.

9. Method according to claim 1, wherein said personalization comprises adding a service in said first secure element.
